(19) United States
(12) Patent Application Publication
(10) Pub. No.: US 2022/0314473 A1
(43) Pub. Date: Oct. 6, 2022

(54) BLADE UNIT AND ELECTRIC RAZOR

(71) Applicant: Panasonic Intellectual Property Management Co., Ltd., Osaka (JP)

(72) Inventors: Shunsuke KOMORI, Shiga (JP); Toshiharu HASHIMOTO, Osaka (JP); Shoki OKURA, Shiga (JP); Atsutaka IKEMOTO, Shiga (JP)

(21) Appl. No.: 17/586,247

(22) Filed: Jan. 27, 2022

(30) Foreign Application Priority Data
Mar. 30, 2021 (JP) 2021-058840

(51) Int. Cl. B26B 19/10; B26B 19/38

(52) U.S. Cl. CPC B26B 19/10; B26B 19/3813

(57) ABSTRACT

The present disclosure provides an electric razor that reduces damage to the skin during shaving. Electric razor according to the present disclosure comprises head portion that holds comb-shaped outer blade and mesh-shaped outer blades each extending in a first direction so as to be movable in a second direction intersecting the first direction, comb blade urging members that urge comb-shaped outer blade in the second direction, mesh blade urging members that urge mesh-shaped outer blades in the second direction, and engaging mechanism that, when mesh-shaped outer blades are moved toward unit base against urging force of mesh blade urging members, moves comb-shaped outer blade in a state where comb-shaped outer blade does not project from mesh-shaped outer blades with respect to unit base.

### BACKGROUND

### 1. Technical Field

The present disclosure relates to a blade unit for shaving a body hair of an animal such as a human, and an electric razor.

### 2. Description of the Related Art

Conventionally, there is a blade unit comprising a plurality of types of outer blades. Such a blade unit is used for an electric razor. When the blade unit is pressed against a skin surface when using an electric razor, the blade unit is configured such that each outer blade sinks independently according to the unevenness of the skin. The blade unit described in PTL 1 employs a mechanism in which each outer blade sinks independently within a predetermined range, and each outer blade sinks in conjunction with each other when the predetermined range is exceeded.

### CITATION LIST

### Patent Literature

PTL 1: Unexamined Japanese Patent Publication No. H11-267376

### SUMMARY

However, the conventional blade unit has a structure that allows other types of outer blades to sink more than a slit-shaped outer blade that scoops up and cuts relatively long hair, so that an edge of a tip of the slit-shaped outer blade could cause severe damage to the skin.

The present disclosure has been made in view of the above problem, and an object of the present disclosure is to provide a blade unit in which an outer blade for scooping up body hair does not project more than other types of outer blades, and an electric razor provided with the blade unit.

In order to achieve the above object, the electric razor, which is one of the present disclosures, is an electric razor comprising a head portion comprising a comb-shaped outer blade and at least one mesh-shaped outer blade, the head portion holding the comb-shaped outer blade and the at least one mesh-shaped outer blade each extending in a first direction so as to be movable in a second direction intersecting the first direction, wherein the electric razor comprises a comb blade urging member that urges the comb-shaped outer blade with respect to the head portion in the second direction, a mesh blade urging member that urges the at least one mesh-shaped outer blade with respect to the head portion in the second direction, and an engaging mechanism that, when the at least one mesh-shaped outer blade is moved toward the head portion against urging force of the mesh blade urging member, moves the comb-shaped outer blade in a state where the at least one mesh-shaped outer blade projects from the comb-shaped outer blade with respect to the head portion.

Furthermore, in order to achieve the above object, another blade unit of the present disclosure is a blade unit configured to be attached to an electric razor, comprising a comb-shaped outer blade and at least one mesh-shaped outer blade, the blade unit comprising a unit base that holds the comb-shaped outer blade extending and the at least one mesh-shaped outer blade each in a first direction so as to be movable in a second direction intersecting the first direction, a comb blade urging member that urges the comb-shaped outer blade with respect to the unit base in the second direction, a mesh blade urging member that urges the at least one mesh-shaped outer blade with respect to the unit base in the second direction; and an engaging mechanism that, when the at least one mesh-shaped outer blade is moved toward the unit base against urging force of the mesh blade urging member, moves the comb-shaped outer blade in a state where the comb-shaped outer blade does not project from the at least one mesh-shaped outer blade with respect to the unit base.

In the present disclosure, while the comb-shaped outer blade exerts a higher scooping effect than the mesh-shaped outer blades for hairs growing in different directions or lying hairs, it is possible to achieve both a high hair scooping effect and suppression of damage to the skin due to the mechanism that prevents the comb-shaped outer blade from projecting more than the mesh-shaped outer blades.

### BRIEF DESCRIPTION OF THE DRAWINGS

FIG. 1 is a perspective view illustrating an electric razor according to the present exemplary embodiment;

FIG. 2 is a perspective view illustrating a blade unit according to the present exemplary embodiment;

FIG. 3 is a perspective view illustrating a comb-shaped outer blade according to the present exemplary embodiment;

FIG. 4 is a side view of the comb-shaped outer blade according to the present exemplary embodiment;

FIG. 5 is a perspective view illustrating the vicinity of open blade portions and bent blade portions according to the present exemplary embodiment;

FIG. 6 is a plan view illustrating the vicinity of the open blade portions and the bent blade portions according to the present exemplary embodiment;

FIG. 7 is a diagram illustrating a state in which the bent blade portion and the open blade portion are arranged in a first direction and viewed from the first direction;

FIG. 8 is a perspective view illustrating a comb blade unit having the comb-shaped outer blade according to the present exemplary embodiment in an exploded manner;

FIG. 9 is a perspective view illustrating the comb blade unit in an assembled state according to the present exemplary embodiment;

FIG. 10 is a perspective view illustrating a mesh-shaped blade unit having a mesh-shaped outer blade according to the present exemplary embodiment in an exploded manner;

FIG. 11 is a perspective view illustrating the mesh-shaped blade unit in the assembled state according to the present exemplary embodiment;

FIG. 12 is a perspective view illustrating the blade unit according to the present exemplary embodiment in an exploded manner;

FIG. 13A is a diagram illustrating an operating state of an engaging mechanism according to the present exemplary embodiment;

FIG. 13B is a diagram illustrating an operating state of the engaging mechanism according to the present exemplary embodiment;

FIG. 13C is a diagram illustrating an operating state of the engaging mechanism according to the present exemplary embodiment;

FIG. 13D is an enlarged view of a part surrounded by broken line L1 in FIG. 13C;

FIG. 14 is a side view illustrating the blade unit in a transparent state of a comb blade holding member and a mesh blade holding member according to the present exemplary embodiment;

FIG. 15 is a perspective view illustrating first another example of the shape of a comb-shaped outer blade;

FIG. 16 is a perspective view illustrating second another example of the shape of the comb-shaped outer blade;

FIG. 17 is a perspective view illustrating third another example of the shape of the comb-shaped outer blade;

FIG. 18 is a perspective view illustrating fourth another example of the shape of the comb-shaped outer blade;

FIG. 19 is a perspective view illustrating fifth another example of the shape of the comb-shaped outer blade;

FIG. 20 is a perspective view illustrating sixth another example of the shape of the comb-shaped outer blade; and

FIG. 21 is a cross-sectional view illustrating seventh another example of the shape of the comb-shaped outer blade.

### DETAILED DESCRIPTION

Hereinafter, exemplary embodiments of a comb-shaped outer blade, a blade unit, and an electric razor according to the present disclosure will be described with reference to the drawings. It should be noted that the following exemplary embodiments are intended to give an example for explaining the present disclosure, and are not intended to limit the present disclosure. For example, a shape, a structure, a material, a component, a relative positional relationship, a connection state, a numerical value, a mathematical formula, contents of each stage in a method, an order of each stage, etc. shown in the following exemplary embodiments are examples, and may include contents that are not described below. Furthermore, geometric expressions such as parallel and orthogonal may be used, but these expressions do not indicate mathematical rigor, and include substantially permissible errors and deviations. In addition, expressions such as simultaneous and identical also include a substantially permissible range.

Furthermore, the drawings are schematic views in which emphasis, omission, and ratio adjustment are appropriately performed in order to describe the present disclosure, and may be different from actual shapes, positional relationships, and ratios.

Further, in the following, a plurality of disclosures may be comprehensively described as one exemplary embodiment. In addition, some of the contents described below are described as arbitrary components relating to the present disclosure.

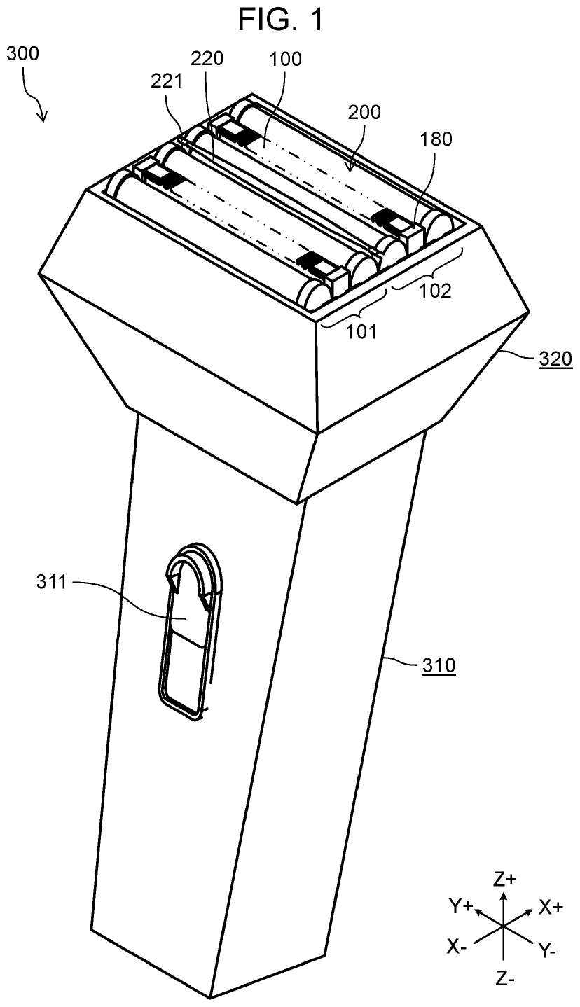

FIG. 1 is a perspective view illustrating electric razor 300. Note that electric razor 300 has a portion where an edge has been chamfered and unevenness for slip prevention has been provided, but these are not illustrated.

Electric razor 300 is a device for cutting and removing body hair such as a beard using an electric blade, and includes grip portion 310 and head portion 320.

Grip portion 310 is a portion gripped by a user when using electric razor 300. In the case of the present exemplary embodiment, grip portion 310 also functions as a housing for accommodating a control device that controls the drive of a shaving blade, a battery, and the like. Power-supply switch 311 or the like for turning on or off a power supply is provided on an outer surface of grip portion 310.

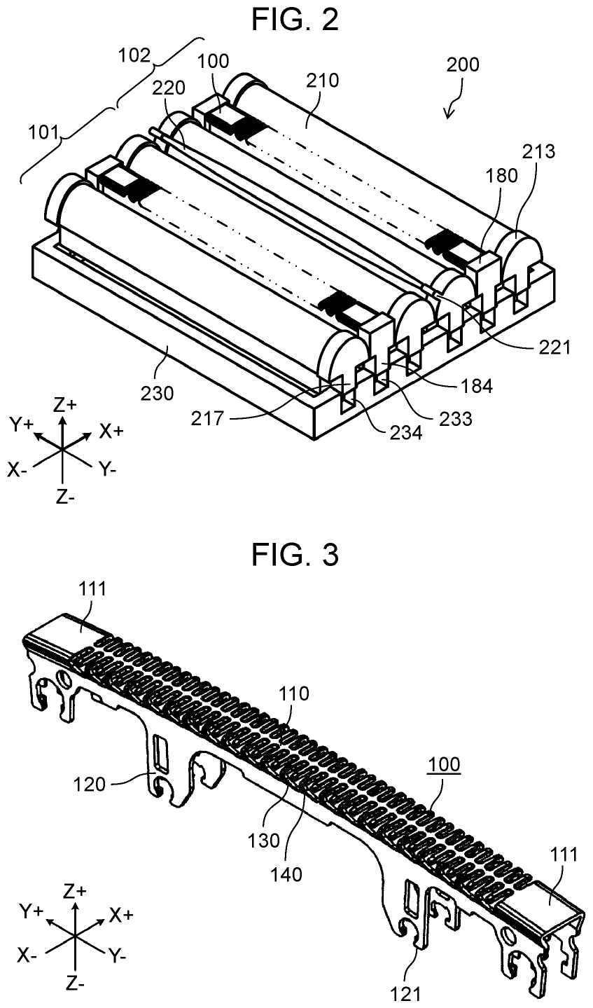

Head portion 320 is a member to which blade unit 200 provided with a blade for cutting body hair is detachably attached and connected to one end of grip portion 310. In the case of the present exemplary embodiment, head portion 320 is relatively operably connected to grip portion 310. In the present exemplary embodiment, a Y-axis direction is a direction in which an outer blade and a sliding member extend, an X-axis direction is a direction in which the outer blade and the sliding member are arranged in parallel, and a Z-axis direction is a direction in which the outer blade is movable with respect to unit base 230 (see FIG. 2) when the outer blade receives external force.

FIG. 2 is a perspective view illustrating blade unit 200. Blade unit 200 is a unit to be replaced in head portion 320 when a blade or the like deteriorates due to the use of electric razor 300, and includes comb-shaped outer blade 100, mesh-shaped outer blades 210, sliding member 220, and unit base 230. Note that comb-shaped outer blade 100 and mesh-shaped outer blades 210 may be collectively referred to as outer blades.

In the case of the present exemplary embodiment, in a first direction (the Y-axis direction in the drawing) in which the outer blades extend, and a second direction (the Z-axis direction in the drawing) in which the outer blades move with respect to unit base 230, and a third direction (the X-axis direction in the drawing) that intersects the first and second directions, blade unit 200 includes first set 101 and second set 102, each of which is a set of blades in which mesh-shaped outer blades 210 are arranged on both sides of comb-shaped outer blade 100. First set 101 is configured by three outer blades, each having a different function, and along the third direction, first mesh-shaped outer blades 210 suitable for shaving short hair, comb-shaped outer blade 100 suitable for shaving long hair, and second mesh-shaped outer blades 210 suitable for shaving frizzy beards in addition to shaving short hair are arranged in this order. Furthermore, second set 102 also has three outer blades having the same configuration as first set 101. First set 101 and second set 102 are attached to unit base 230 so as to be symmetrical with respect to a plane including the first direction and the second direction, and form six outer blades. With this arrangement, comb-shaped outer blade 100 is disposed next to mesh-shaped outer blades 210 in any of moving directions (X-axis direction in the drawing) of electric razor 300 during shaving, and even when body hair in a narrow area such as under the nose is shaved, comb-shaped outer blade 100 comes into contact with the skin, and it is possible to scoop up and cut relatively long body hair.

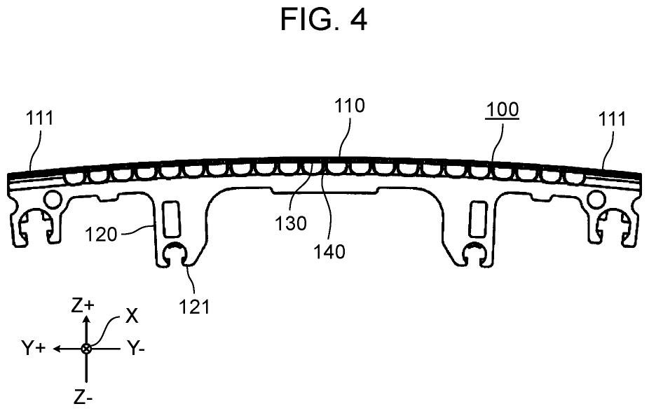

FIG. 3 is a perspective view illustrating comb-shaped outer blade 100. FIG. 4 is a side view of comb-shaped outer blade 100. The shape of comb-shaped outer blade 100 is not particularly limited as long as slits extending in the third direction are arranged in the first direction. In the case of the present exemplary embodiment, comb-shaped outer blade 100 is an outer blade attached to electric razor 300, and includes base portion 110, attaching portion 120, open blade portion 130, and bent blade portion 140. In the case of the present exemplary embodiment, in comb-shaped outer blade 100, base portion 110, attaching portion 120, open blade portions 130, and bent blade portions 140 are integrally formed by punching and bending sheet metal with a press. Note that a processing method of comb-shaped outer blade 100 may be sintering, injection molding, etching processing or electroforming processing, or may be produced by welding two members.

Base portion 110 is a rod-shaped portion extending in the first direction (Y-axis direction in the drawing). At both end portions of base portion 110, long end portions 111 having the same bending shape as bent blade portion 140 and longer in the first direction than bent blade portion 140 are provided. In the case of the present exemplary embodiment, base portion 110 is curved in an arc shape such that a central portion projects forward (Z+ side in the drawing) from both ends in a plane extending in the first direction and the second direction which is orthogonal to the first direction (inside the YZ plane in the drawing). Along with this, the plurality of open blade portions 130 and the plurality of bent blade portions 140 are arranged along the curvature of base portion 110. Since comb-shaped outer blade 100 is curved in a convex shape, comb-shaped outer blade 100 can be fitted to a recessed portion such as under a human chin, and shaving efficiency can be improved.

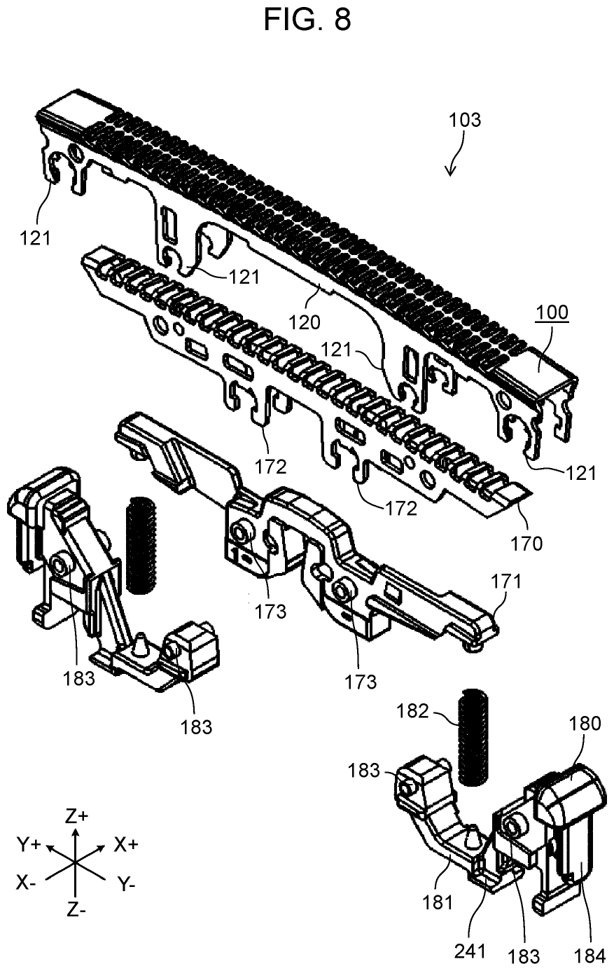

Attaching portion 120 is a plate-shaped portion extending in the first direction and in the second direction which is orthogonal to the first direction. In the case of the present exemplary embodiment, attaching portion 120 includes outer blade engaging claws 121 that engages with outer blade protruding portions 183 of comb blade holding members 180, which will be described later (see FIG. 8).

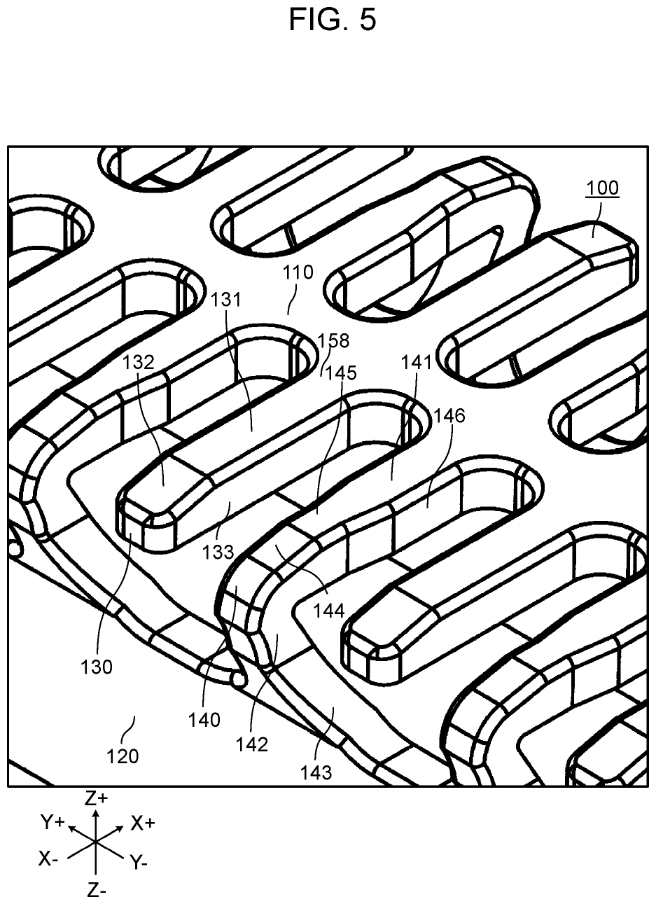

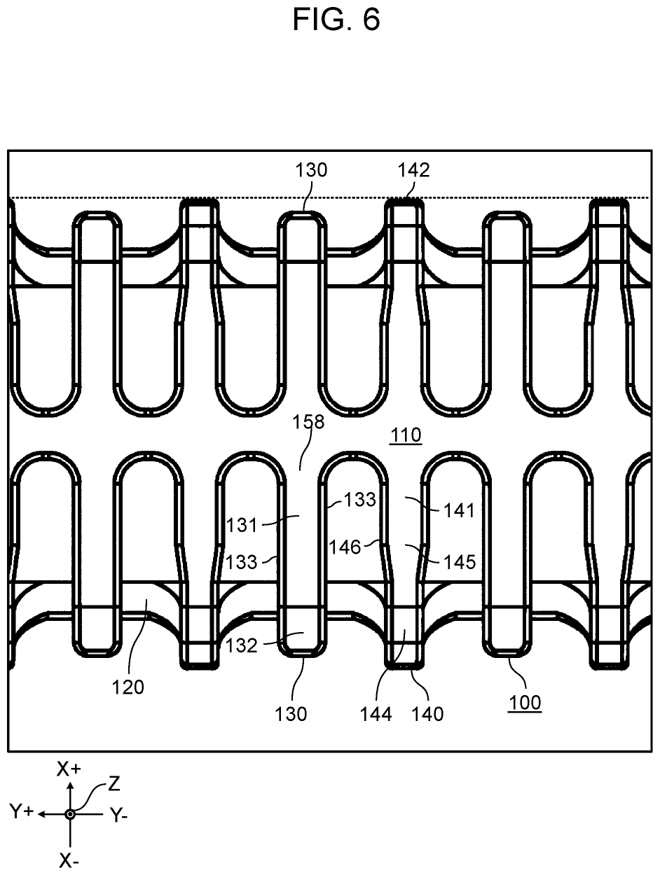

FIG. 5 is a perspective view illustrating the vicinity of open blade portions 130 and bent blade portions 140. FIG. 6 is a plan view illustrating the vicinity of open blade portions 130 and bent blade portions 140. Open blade portion 130 is a cantilever rod-shaped portion projecting from base portion 110 in the third direction (X-axis direction in the drawing) orthogonal to the first direction and the second direction, and scoops up so-called lying body hair with a tip in an open state, guides it between the adjacent blade portions, and cuts the body hair with first inner blade 170, details of which will be described later (see FIG. 8), that reciprocates relatively.

In the case of the present exemplary embodiment, open blade portion 130 extends in the first direction and the third direction (XY plane in the drawing), includes open upper surface portion 131 that is flush with base portion 110, and has a rectangular rod shape as a whole.

A tip of open upper surface portion 131 in the third direction includes open inclined surface portion 132 that approaches attaching portion 120 as a distance from base portion 110 increases. The thickness of the tip of open blade portion 130 (the length in the Z-axis direction in the drawing) reduces at open inclined surface portion 132, so that even body hair extending along the edge of a skin surface can be effectively scooped up.

The corners of open upper surface portion 131 and open side surface portion 133 of open blade portion 130 are loosely connected by R chamfering or the like. Furthermore, open side surface portion 133 and open inclined surface portion 132, and open inclined surface portion 132 and a surface of the tip are also loosely connected by R chamfering or the like. As a result, damage to the skin when comb-shaped outer blade 100 rubs against the skin surface is reduced.

Bent blade portions 140 are arranged side by side with open blade portions 130 in the first direction, and are portions connected to base portion 110 and attaching portion 120. In the case of the present exemplary embodiment, bent blade portions 140 and open blade portions 130 are arranged side by side in parallel alternately. The inventors have obtained knowledge by experiment that, even when bent blade portions 140 and open blade portions 130 are arranged alternately, it is possible to obtain the same body hair scooping effect as when the plurality of open blade portions 130 are arranged between bent blade portions 140. Furthermore, this makes it possible to maintain a high structural strength of comb-shaped outer blade 100.

Bent blade portion 140 includes projecting portion 141 projecting from base portion 110 along the third direction, bent portion 142 bending (i.e., curving) from a tip of projecting portion 141 toward attaching portion 120, and connecting portion 143. Connecting portion 143 is inclined in such a manner that connecting portion 143 approaches base portion 110 in the third direction as a distance from bent portion 142 increases in the second direction and that connecting portion 143 connects bent portion 142 with attaching portion 120. By using bent blade portion 140 having such a shape, an angle formed by projecting portion 141 and connecting portion 143 is an acute angle, so that bent portion 142 arranged at the tip effectively scoops up the lying body hair while reducing damage to the skin, and can guide the body hair between the adjacent blade portions.

In the case of the present exemplary embodiment, as shown by a broken line in FIG. 6, the end faces of the plurality of bent portions 142 are located at the same distance from base portion 110 in the third direction, and are arranged at positions farther from the tip surfaces of open blade portions 130 with respect to base portion 110. As a result, the tips of bent blade portions 140 come into contact with the skin before the tips of open blade portions 130, so that comb-shaped outer blade 100 as a whole can exert a high body hair scooping effect while reducing damage to the skin.

Furthermore, bent blade portion 140 includes bent inclined surface 144 disposed in substantially the same plane as the open inclined surface portion of adjacent open blade portions 130, and the thickness of bent portion 142 in the second direction is reduced to improve the effect of scooping up body hair. Similar to open blade portion 130, bent blade portion 140 has a corner portion between bent upper surface portion 145 and bent side surface portion 146 loosely connected by R chamfering or the like to reduce damage to the skin. The tip of projecting portion 141 of bent blade portion 140 is narrower than base end portion 158 (namely, the length of projecting portion 141 in the first direction is shorter than that of base end portion 158). Base end portion 158 refers to a root portion of open blade portion 130 connected to base portion 110. As a result, the effect of guiding the scooped hair between the adjacent blade portions can be enhanced.

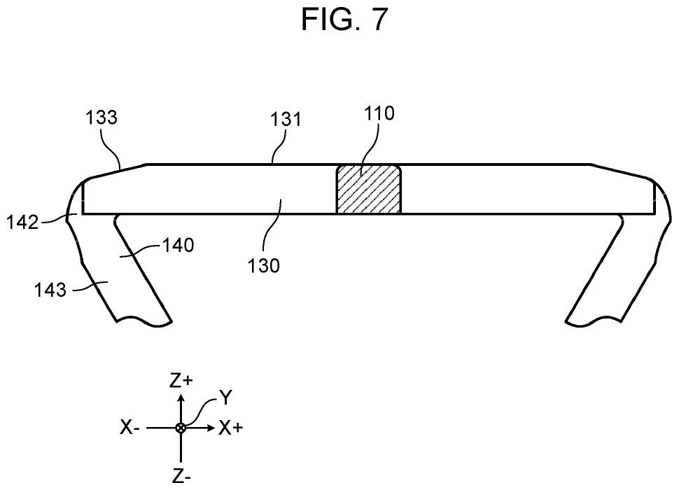

Further, as illustrated in FIG. 7, when bent blade portions 140 and opening blade portions 130 are arranged in the first direction, bent blade portions 140 are formed such that none of the parts of opening blade portions 130 project from bent blade portions 140.

As a result, damage to the skin of comb-shaped outer blade 100 is suppressed.

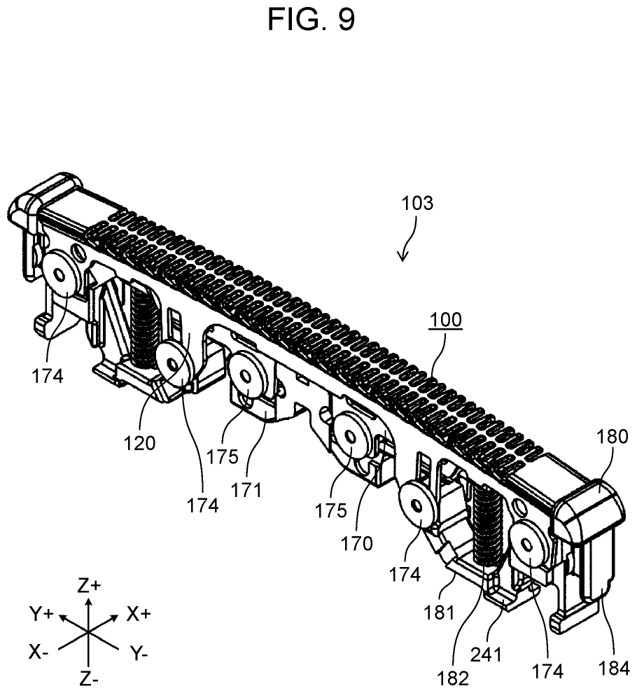

FIG. 8 is a perspective view illustrating comb blade unit 103 having comb-shaped outer blade 100 in an exploded manner. FIG. 9 is a perspective view illustrating comb blade unit 103 in an assembled state. As illustrated in these figures, comb blade unit 103 includes comb-shaped outer blade 100, first inner blade 170, comb blade holding members 180, first urging members 182, and first joint member 171.

First inner blade 170 is disposed inside comb-shaped outer blade 100 (that is, on an opposite side of the skin contact surface), and reciprocates in the first direction while rubbing against comb-shaped outer blade 100, thereby cutting body hair inserted between the adjacent blades of comb-shaped outer blade 100 (that is, between open side surface portion 133 and bent side surface portion 146). In the case of the present exemplary embodiment, first inner blade 170 has a shape in which slits are arranged in the first direction. First inner blade 170 is fixedly attached to first resin joint member 171. In first inner blade 170, a drive connecting portion (not illustrated) extending from head portion 320 is inserted into a recess provided in the center of first joint member 171 to apply reciprocating driving force. First joint member 171 is not specified as resin. The drive connecting portion is not specified as long as it can perform a function of drive transmission such as a metal pin or a molded product, or a round shape or a square shape.

Comb blade holding members 180 are resin members that are fixedly attached to both end portions of comb-shaped outer blade 100 in the first direction. Comb blade holding members 180 integrally include first facing portions 181 facing first inner blade 170 in the second direction. First urging member 182 connected to first joint member 171 is attached to first facing portion 181. First urging member 182 is a coil spring or the like, and allows reciprocating movement of first inner blade 170 while pressing first inner blade 170 against a back surface of comb-shaped outer blade 100 via first joint member 171 on the basis of first facing portion 181.

A method of joining comb-shaped outer blade 100 and comb blade holding members 180 is not particularly limited. In the case of the present exemplary embodiment, comb-shaped outer blade 100 and comb blade holding members 180 are temporarily fixed by engaging outer blade protruding portions 183 of comb blade holding members 180 and outer blade engaging claws 121 of attaching portion 120 with each other. Then, the tips of outer blade protruding portions 183 are melted and expanded to form first melt-expanded portions 174, and comb-shaped outer blade 100 and comb blade holding members 180 are fixed. Furthermore, a material of comb blade holding members 180 is not limited to resin, and a method of fixing comb blade holding members 180 to comb-shaped outer blade 100 may be one of caulking, hook engagement and welding, or a combination thereof.

A method of joining first inner blade 170 and first joint member 171 is not particularly limited. In the case of the present exemplary embodiment, the method of joining first inner blade 170 and first joint member 171 is the same as the method of joining comb-shaped outer blade 100 and comb blade holding members 180. First inner blade 170 made of metal is provided with inner blade engaging claws 172, and is temporarily fixed by hook-engaging to cylindrical inner blade engaging protrusions 173 provided on first joint member 171. Then, the tips of inner blade engaging protrusions 173 are melted and expanded to form second melt-expanded portions 175, and the first inner blade and first joint member 171 are fixed. Although first melt-expanded portions 174 and second melt-expanded portions 175 are simplified and drawn in FIG. 9, first melt-expanded portion 174 and second melt-enlarged portion 175 are portions in which resin is melted, expanded and hardened, and actually have a complicated shape.

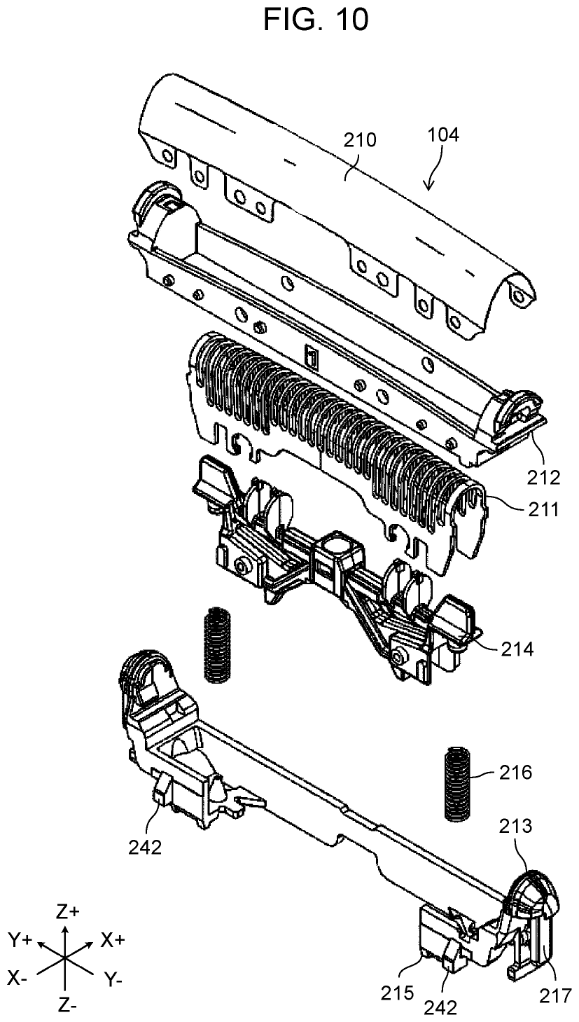

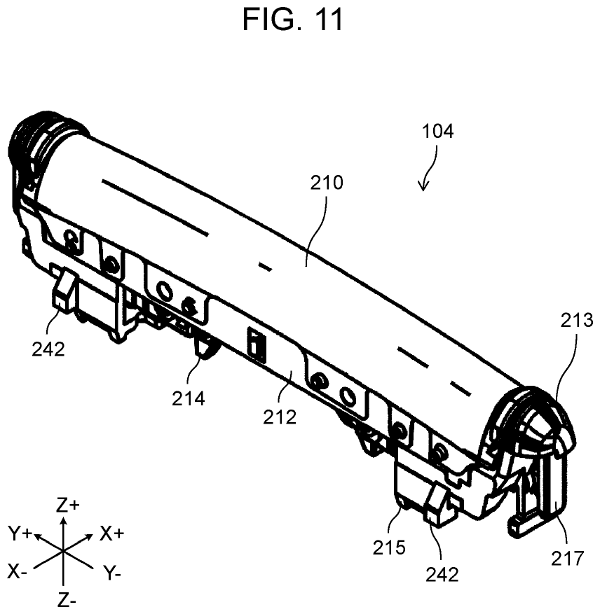

FIG. 10 is a perspective view illustrating mesh-shaped blade unit 104 having mesh-shaped outer blades 210 in an exploded manner. FIG. 11 is a perspective view illustrating mesh-shaped blade unit 104 in the assembled state. As illustrated in these figures, mesh-shaped blade unit 104 includes mesh-shaped outer blades 210, second inner blade 211, mesh blade fixing member 212, mesh blade holding members 213, second urging member 216, and second joint member 214.

Mesh-shaped outer blades 210 is an outer blade for an electric razor attached to electric razor 300, and extends in the first direction along comb-shaped outer blade 100, and is curved in a plane extending in the second direction and the third direction (in the XZ plane in the drawing). In the case of the present exemplary embodiment, similarly to base portion 110 of comb-shaped outer blade 100, mesh-shaped outer blades 210 is curved in an arc shape such that a central portion projects forward (Z+ side in the drawing) from both ends in a plane extending in the first direction and the second direction (inside the YZ plane in the drawing). In addition, since mesh-shaped outer blades 210 is curved in a convex shape, comb-shaped outer blade 100 can be fitted to a recessed part such as under a person's jaw, and the effect that makes it possible to improve the shaving efficiency is the same as that of comb-shaped outer blade 100, and the effect can be further enhanced because of the curves of both comb-shaped outer blade 100 and mesh-shaped outer blades 210.

Mesh-shaped outer blades 210 is a semi-cylindrical outer blade having a plurality of through-holes in a mesh shape, and is used for cutting relatively short body hair. In the case of the present exemplary embodiment, mesh-shaped outer blades 210 is formed by processing a large number of through-holes by pressing on a sheet metal thinner than the sheet metal constituting comb-shaped outer blade 100, and is fixed to resin-made mesh blade fixing member 212 so as to maintain a curved state. Note that, a processing method of mesh-shaped outer blades 210 may be sintering, injection molding, etching processing, or electroforming, and a method of fixing mesh-shaped outer blades 210 and mesh blade fixing member 212 may be a processing method such as welding with two members, or another processing method or fixing method.

Second inner blade 211 is disposed inside mesh-shaped outer blades 210 and reciprocates in the first direction while rubbing against mesh-shaped outer blades 210, so that relatively short body hairs inserted into the through-holes of mesh-shaped outer blades 210 are cut. In the case of the present exemplary embodiment, second inner blade 211 has a shape in which arch-shaped blades each of which is curved in a plane extending in the second direction and the third direction have been arranged in the first direction in such a manner that a slit is interposed between adjacent two arch-shaped blades. Second inner blade 211 is fixedly attached to second joint member 214 made of resin. In second inner blade 211, a drive connecting portion (not illustrated) extending from head portion 320 is inserted into a recess provided in the center of second joint member 214 to apply reciprocating driving force. Note that the drive connecting portion may be a metal pin or a molded product as a material, and a round shape, a square shape, or the like as a shape, and is not particularly limited as long as a drive transmission function can be achieved.

Mesh blade holding members 213 are resin members that are fixedly attached to both end portions of mesh-shaped outer blades 210. Mesh blade holding members 213 integrally include second facing portions 215 facing second inner blade 211 in the second direction. Second urging member 216 connected to second joint member 214 is attached to second facing portion 215. Second urging member 216 is a coil spring or the like, and allows reciprocating movement of second inner blade 211 while pressing second inner blade 211 against a back surface of mesh-shaped outer blades 210 (that is, a reverse side of the skin contact surface) via second joint member 214 on the basis of second facing portion 215. Furthermore, mesh blade holding members 213 are not limited to resin.

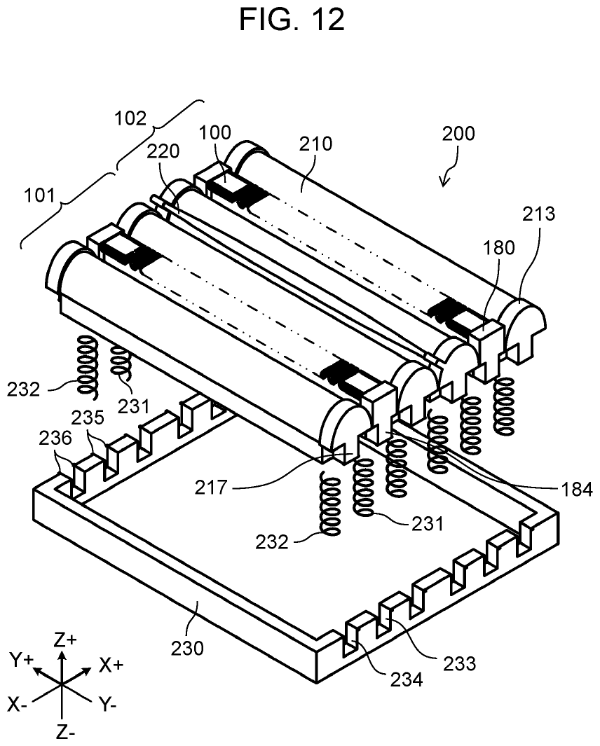

FIG. 12 is a perspective view illustrating blade unit 200 in an exploded manner. Unit base 230 is a member that movably holds comb-shaped outer blades 100 and mesh-shaped outer blades 210 in the second direction (Z-axis direction in the drawing) and in a plane formed by the first direction and the second direction (obliquely). Here, “oblique” means a direction that intersects the Z-axis in the YZ plane. In other words, the movable directions of comb-shaped outer blades 100 and mesh-shaped outer blades 210 include not only a direction strictly along the Z-axis but also a direction substantially along the Z-axis. In the case of the present exemplary embodiment, unit base 230 includes first guide portions 233 that guide comb-shaped outer blade 100 in the second direction via comb blade holding members 180 of comb blade unit 103.

Unit base 230 includes second guide portions 234 that guide mesh-shaped outer blades 210 in the second direction via mesh blade holding members 213 of mesh-shaped blade unit 104. In the case of the present exemplary embodiment, first guide portions 233 and second guide portions 234 are provided with grooves penetrating in the first direction and extending in the second direction in a frame portion of unit base 230. First guide portions 233 engage with a pair of first ridge portions 184 provided on comb blade holding members 180, and guide the movement of comb blade unit 103 in the plane formed by the first direction and the second direction. Second guide portions 234 engage with a pair of second ridge portions 217 provided on mesh blade holding members 213, and guide the movement of mesh-shaped blade unit 104 in the plane formed by the first direction and the second direction.

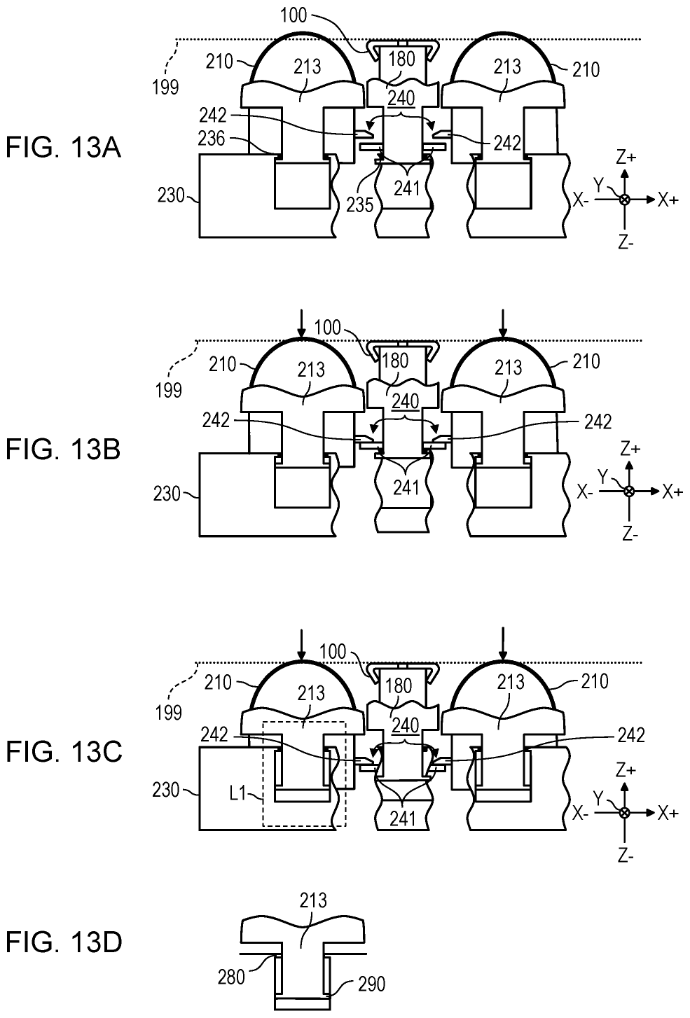

Furthermore, first guide portions 233 include first regulation portions 235 that regulate an amount of projection of comb blade unit 103 with respect to unit base 230, and second guide portions 234 include second regulation portions 236 that regulate an amount of projection of mesh-shaped blade unit 104 with respect to unit base 230. First regulation portions 235 and second regulation portions 236 have fixed side protruding portions 280 (see FIG. 13D) provided on a surface portion of unit base 230 on an outward (Z+ direction in the drawing) side in the second direction. Fixed side protruding portions 280 are formed in a shape projecting in the third direction so as to cover a part of the grooves provided as first guide portions 233 and second guide portions 234. Further, comb blade holding members 180 of comb blade unit 103 and mesh blade holding members 213 of mesh-shaped blade unit 104 are provided with blade unit side protruding portions 290 (see FIG. 13D) protruding in the third direction at end portions in the second direction thereof, and blade unit side protruding portions 290 face fixed side protruding portions 280 in the second direction. Due to first regulation portions 235 and second regulation portions 236 having such a configuration, when comb blade unit 103 and mesh-shaped blade unit 104 are urged and moved outward (Z+ direction in the drawing) in the second direction by comb blade urging members 231 and mesh blade urging members 232, and blade unit side protruding portions 290 reach positions of fixed side protruding portions 280, blade unit side protruding portions 290 come into contact with fixed side protruding portions 280, so that comb blade unit 103 and mesh-shaped blade unit 104 are regulated so as not to project further outward (Z+ direction in the drawing) in the second direction. Then, as illustrated in FIG. 13A, first regulation portions 235 and second regulation portions 236 are arranged such that comb-shaped outer blade 100 of comb blade unit 103 regulated by first regulation portions 235 does not project from mesh-shaped outer blades 210 of mesh-shaped blade units 104 regulated by second regulation portions 236.

As illustrated in FIG. 12, comb blade urging members 231 are members that urge comb-shaped outer blade 100 outward in the second direction (Z+ direction in the drawing) with respect to unit base 230. In the case of the present exemplary embodiment, comb blade urging members 231 are coil springs or the like, and are disposed between unit base 230 and comb blade holding members 180 of comb blade unit 103 at both end portions of comb blade unit 103 in the first direction. When comb-shaped outer blade 100 is not pressed in the second direction, the urging force of comb blade urging members 231 maintain a state in which the movement of comb blade unit 103 is regulated by first regulation portions 235 provided on unit base 230.

Mesh blade urging members 232 are members that urge mesh-shaped outer blades 210 outward in the second direction (Z+ direction in the drawing) with respect to unit base 230. In the case of the present exemplary embodiment, mesh blade urging members 232 are coil springs or the like, and are disposed between unit base 230 and mesh blade holding members 213 of mesh-shaped blade unit 104 at both end portions of mesh-shaped blade unit 104 in the first direction. In the state where mesh-shaped outer blades 210 are not pressed in the second direction, the urging force of mesh blade urging members 232 maintain a state in which the movement of comb blade unit 103 is regulated by first regulating portions 235 provided on unit base 230, and as illustrated in FIG. 13A, top portions of mesh-shaped outer blades 210 are arranged at positions (Z+ side in the drawing) projecting from comb-shaped outer blade 100 at any position in the first direction.

FIGS. 13A to 13C are diagrams illustrating an operating state of engaging mechanism 240. FIG. 13D is an enlarged view of a portion surrounded by broken line L1 in FIG. 13C. Engaging mechanism 240 is a mechanism for moving comb-shaped outer blade 100 in a state where comb-shaped outer blade 100 does not project from mesh-shaped outer blades 210 with respect to unit base 230 when mesh-shaped outer blades 210 are moved toward unit base 230 against the urging force of mesh blade urging members 232. The specific aspect of engaging mechanism 240 is not particularly limited, but in the case of the present exemplary embodiment, engaging mechanism 240 includes first engaging portions 241 and second engaging portions 242.

First engaging portion 241 is a member capable of regulating the movement of comb-shaped outer blade 100 in a projecting direction (Z+ direction in the drawing) by engaging with second engaging portion 242 in the second direction. The arrangement positions and attitudes of first engaging portions 241 are not particularly limited, but the first engaging portions are provided on the pair of comb blade holding members 180, which are included in comb blade unit 103 so as to project toward mesh-shaped blade unit 104.

Second engaging portions 242 are members capable of transmitting force to comb blade unit 103 by engaging with first engaging portions 241, and moving comb-shaped outer blade 100 toward unit base 230 against comb blade urging members 231 when mesh-shaped blade unit 104 is pressed toward unit base 230 in the second direction. The arrangement positions of second engaging portions 242 are located outside first engaging portions 241 (that is, an upper side in the second direction), and second engaging portions 242 engage with first engaging portions 241 to regulate the movement of comb-shaped outer blade 100 in the second direction such that comb-shaped outer blade 100 does not project from mesh-shaped outer blades 210. Second engaging portions 242 are provided at both end portions of mesh blade holding members 213 included in mesh-shaped blade unit 104 in the first direction so as to project toward comb blade unit 103.

The operation mode of engagement mechanism 240 will be described. In the state where mesh-shaped outer blades 210 and comb outer blade 100 are not pressed (FIG. 13A), comb outer blade 100 and mesh-shaped outer blades 210 project most outward. In this state, mesh-shaped outer blades 210 project more than comb-shaped outer blade 100. In FIGS. 13A to 13C, a projecting position of comb-shaped outer blade 100 is indicated by a broken line at position 199. In this state, comb-shaped outer blade 100 and mesh-shaped outer blades 210 can move independently in a sinking direction (that is, the Z-direction in the drawing).

Next, as illustrated in FIG. 13B, by lightly pressing electric razor 300 against the skin, mesh-shaped outer blades 210, which generally project from comb-shaped outer blade 100, are pressed first, and mesh-shaped outer blades 210 begin to sink against mesh blade urging members 232. Then, when mesh-shaped outer blades 210 sink until first engaging portions 241 and second engaging portions 242 of engaging mechanism 240 are engaged, pressing force is applied from second engaging portions 242 to first engaging portions 241, and comb-shaped outer blade 100 begins to sink in conjunction therewith. Even in this state, mesh-shaped outer blades 210 slightly project from comb-shaped outer blade 100.

Further, as illustrated in FIG. 13C, when electric razor 300 is pressed against the skin, an engaged state of first engaging portions 241 and second engaging portions 242 is maintained, and mesh-shaped outer blades 210 and comb-shaped outer blade 100 sink until they are regulated by unit base 230 while maintaining the state in which mesh-shaped outer blades 210 are slightly projected from comb-shaped outer blade 100. In this state, comb-shaped outer blade 100 can move independently in the sinking direction (that is, the Z-direction in the drawing), but both mesh-shaped outer blades 210 move in the sinking direction together with comb-shaped outer blade 100. That is, first engaging portions 241 and second engaging portions 242 included in engaging mechanism 240 are engaged in a direction in which comb-shaped outer blade 100 projects, and comb-shaped outer blade 100 is regulated by engaging mechanism 240 not to project from mesh-shaped outer blades 210. However, since engaging mechanism 240 does not regulate the movement of comb-shaped outer blade 100 in the sinking direction, comb-shaped outer blade 100 may be pressed and sink depending on the shape of the skin.

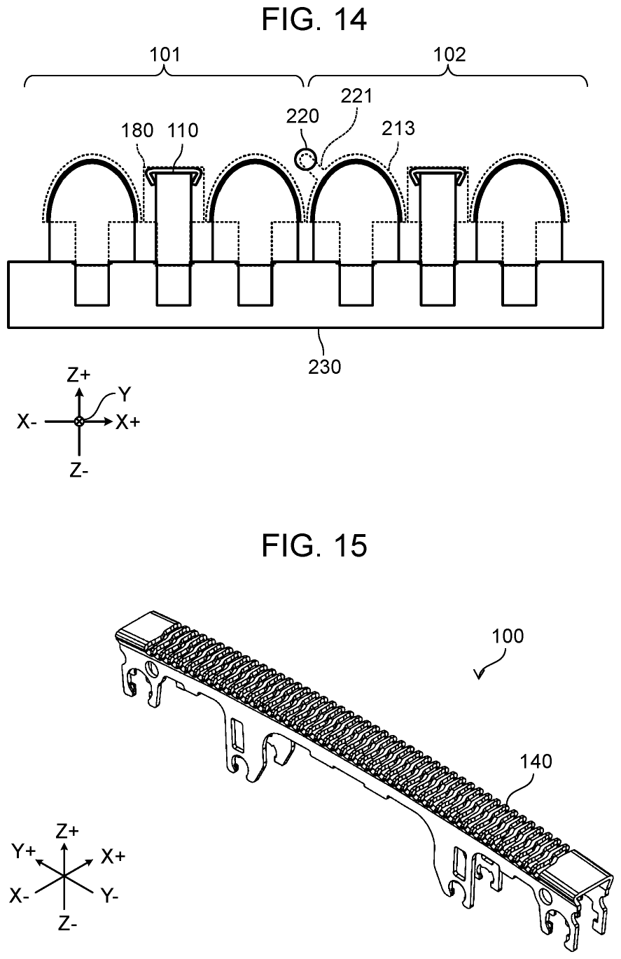

FIG. 14 is a side view illustrating comb blade holding members 180 and mesh blade holding members 213 in a transparent state in blade unit 200. Sliding member 220 is a member that, when entire blade unit 200 is pressed against a wide skin surface, comes into contact with the skin surface, and improves skin sliding when blade unit 200 is slid against the skin surface. The structure of sliding member 220 is not particularly limited, but in the case of the present exemplary embodiment, sliding member 220 is a roller having a rotation axis extending in the first direction (Y-axis direction in the drawing). In the case of the present exemplary embodiment, sliding member 220 has a shape that bulges such that a diameter of the central portion thereof is larger than that of both end portions thereof so as to correspond to a curved shape in the surface extending in the first direction and the second direction (that is, the YZ plane in the drawing) of mesh-shaped outer blades 210. Furthermore, sliding member 220 is disposed so as to project from mesh-shaped outer blades 210 at any position in the first direction when blade unit 200 is not pressed.

Sliding member 220 is attached to a holding member that holds an outer blade disposed in the vicinity thereof. In the case of the present exemplary embodiment, sliding member 220 is rotatably attached to bearing portion 221 projecting diagonally upward from one of mesh blade holding members 213 disposed in the nearest vicinity toward adjacent mesh-shaped outer blades 210. As a result, sliding member 220 can sink in the second direction together with mesh-shaped outer blades 210, and can maintain the state in which the sliding member slightly projects from mesh-shaped outer blades 210. Note that, although sliding member 220 is attached to bearing portion 221 in the present exemplary embodiment, sliding member 220 can also be attached to unit base 230, for example, but it is preferable that the sliding member is attached to bearing portion 221 as in the present exemplary embodiment because the projecting state of sliding member 220 is more stable.

At least two outer blades are arranged on both sides of sliding member 220. In the case of the present exemplary embodiment, the same number of outer blades are arranged on both sides of sliding member 220, three each. That is, blade unit 200 has an even number of outer blades, and sliding member 220 is arranged in the center thereof. In other words, it is sufficient that two or more outer blades are arranged on both sides of sliding member 220, and the number of outer blades arranged on both sides of sliding member 220 is not particularly limited.

Different types of outer blades are arranged on one side of sliding member 220. In the case of the present exemplary embodiment, one of the outer blades is comb-shaped outer blade 100, and the other is mesh-shaped outer blades 210. Blade unit 200 includes first set 101 and second set 102 in which mesh-shaped outer blades 210 are arranged on both sides of comb-shaped outer blade 100, and sliding member 220 is arranged between first set 101 and second set 102. That is, mesh-shaped outer blades 210 are arranged immediately on both sides of sliding member 220. As a result, sliding member 220 can be arranged in a valley space formed by densely arranged mesh-shaped outer blades 210, and entire blade unit 200 can be made compact. Furthermore, sliding member 220 can prevent the skin from being bitten into the valley space when blade unit 200 is pressed against the skin to reduce damage to the skin.

In electric razor 300 and blade unit 200 directed to the above-described exemplary embodiment, comb-shaped outer blade 100 does not project more than mesh-shaped outer blades 210 by engaging mechanism 240 regardless of the shape of the skin surface and the pressing direction of electric razor 300 against the skin. Therefore, it is possible to suppress the damage to the skin caused by the tip of a blade of comb-shaped outer blade 100 strongly biting into the skin. Further, comb-shaped outer blade 100 can effectively scoop up and cut relatively long body hair that grows along the skin surface on the basis of the shape of comb-shaped outer blade 100, even when comb-shaped outer blade 100 does not project more than mesh-shaped outer blades 210.

Note that the present disclosure is not limited to the above exemplary embodiment. For example, another exemplary embodiment achieved by arbitrarily combining the components described in the present specification or excluding some of the components may be an exemplary embodiment of the present disclosure. Further, the present disclosure also includes modifications obtained by making various modifications to the above-described exemplary embodiment, which are conceivable by those skilled in the art without departing from the spirit of the present disclosure, that is, the meaning indicated by the wording described in the claims.

For example, in the above-described exemplary embodiment, the case of six blades has been described, but blade unit 200 may have any number of blades as long as blade unit 200 includes comb-shaped outer blade 100 and mesh-shaped outer blades 210.

Further, as comb-shaped outer blade 100, the case where open blade portions 130 and bent blade portions 140 are alternately arranged with the slit extending in the third direction interposed therebetween has been described, but the shape of comb-shaped outer blade 100 is not limited thereto.

For example, as illustrated in FIG. 15, comb-shaped outer blade 100 may be formed by all bent blade portions 140 without comprising open blade portions 130. As a result, since base portion 110 does not exist and the slit penetrates in the third direction, long hair facing in the opposite direction can also be shaved.

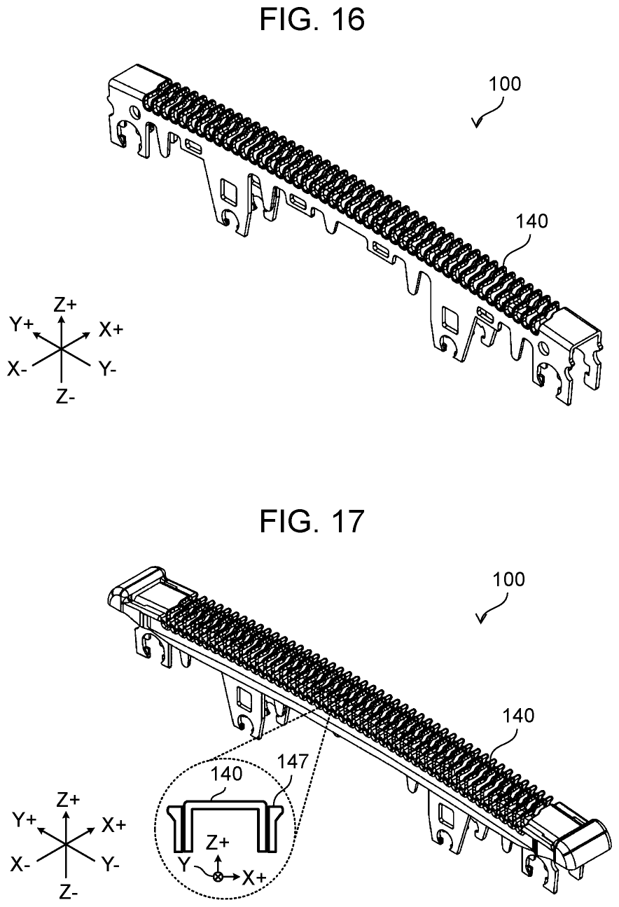

Further, as illustrated in FIG. 16, bent blade portion 140 may be bent by about 90° instead of an acute angle. As a result, long hair can be cut with improved touch on the skin.

Furthermore, as illustrated in FIG. 17, another member 147 (for example, a comb member) adjacent to bent blade portion 140 in the third direction may be provided. This makes it possible to improve the shaving performance of long hair.

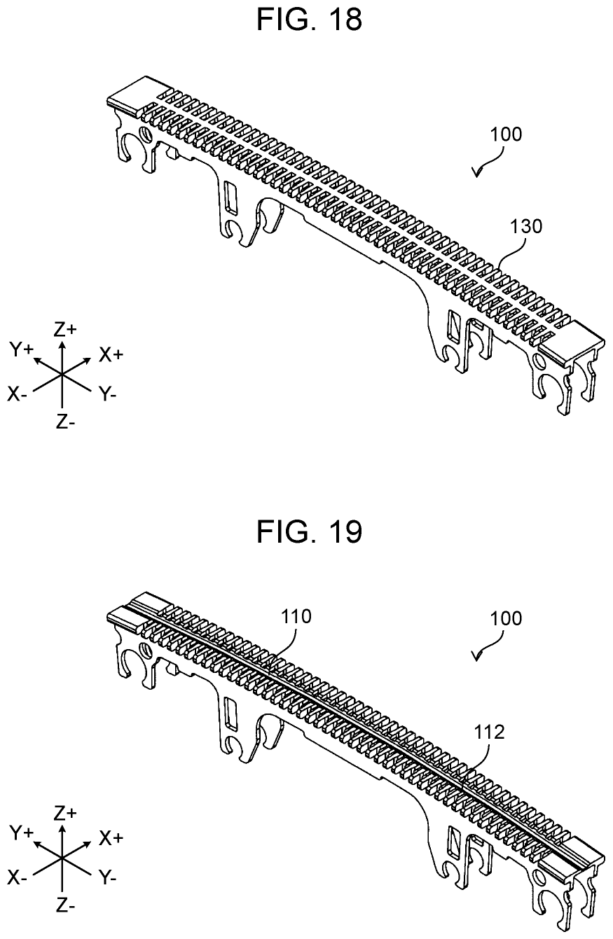

Further, as illustrated in FIG. 18, comb-shaped outer blade 100 may be formed by all open blade portions 130 without comprising bent blade portions 140. This makes it possible to improve the shaving performance of long hair.

Further, as illustrated in FIG. 19, a part of base portion 110 may be provided with recess portion 112 that is recessed in the second direction and extends in the first direction. As a result, it is possible to increase the possibility of re-standing long hair that has not been scooped and introducing it into the slit, and to improve the shaving performance of the long hair.

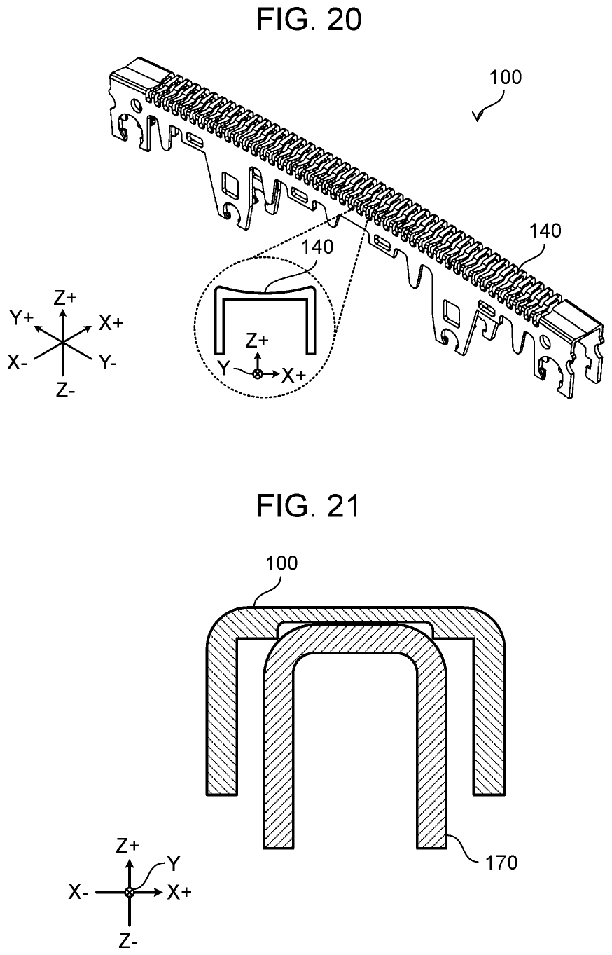

Further, as illustrated in FIG. 20, in the third direction, both end portions of bent blade portion 140 may project outward in the second direction. This makes it possible to improve the shaving performance of long hair.

Further, as illustrated in FIG. 21, the wall thickness of a part of comb-shaped outer blade 100 in contact with first inner blade 170 may be reduced. Thereby, comb-shaped outer blade 100 can shave long hair shorter, and mesh-shaped outer blades 210 can shave body hair to a length that is easy to insert.

Further, the plurality of bent blade portions 140 may be arranged between adjacent open blade portions 130, and the plurality of open blade portions 130 may be arranged between adjacent bent blade portions 140.

Further, comb-shaped outer blade 100 and mesh-shaped outer blades 210 may be not only integrally shaped from sheet metal but also formed by joining a plurality of members by welding or the like. Specifically, for example, base portion 110 and at least one of open blade portions 130 and bent blade portions 140 are integrally formed, and comb-shaped outer blade 100 may be formed by joining long end portion 111 and attaching portion 120, both of which have been separately formed, to base portion 110 and the other of open blade portions 130 and bent blade portions 140 by welding or the like.

Further, although open blade portions 130 and bent blade portions 140 are arranged symmetrically with respect to base portion 110, open blade portions 130 and bent blade portions 140 may be arranged side by side in the third direction.

Further, the width of a tip end portion (that is, the length in the first direction) of open blade portion 130 may be narrower than the width of base end portion 158, similarly to bent blade portion 140.

Further, although the case where blade unit 200 can be attached to and detached from head portion 320 together with unit base 230 has been described, head portion 320 may have a portion having the same function as unit base 230.

Further, although first regulation portions 235 and second regulation portions 236 that regulate the projection amount of comb blade unit 103 and mesh-shaped blade unit 104 with respect to unit base 230 have been described, the structure that regulates the projection amount of comb-shaped outer blade 100 and mesh-shaped outer blades 210 is not limited to this. For example, unit base 230 is provided with a groove extending in the second direction and having both of closed end portions in an extending direction, and either comb blade unit 103 or mesh-shaped blade unit 104 may be provided with a protrusion that is inserted into the groove of the unit base 230 and moves along the groove. In this case, the amount of projection is regulated by the protrusion coming into contact with the end portion of the groove. Further, with respect to the groove and the protrusion, contrary to the above-described structure, unit base 230 may be provided with the protrusion, and comb blade unit 103 and mesh-shaped blade unit 104 may be provided with the groove.

Further, the regulation portions that regulates the projection amount of comb blade unit 103 and mesh-shaped blade unit 104 with respect to unit base 230 are not limited to unit base 230, comb blade unit 103, and mesh-shaped blade unit 104, and regulation portions may be provided at other positions according to the projection amount.

The present disclosure can be applied to an electric razor capable of shaving body hair of animals including humans, such as a so-called electric shaver for shaving a beard.

What is claimed is:

1. An electric razor comprising:
a head portion comprising:
a comb-shaped outer blade; and
at least one mesh-shaped outer blade,
the head portion holding the comb-shaped outer blade and the at least one mesh-shaped outer blade each extending in a first direction so as to be movable in a second direction intersecting the first direction,
wherein the electric razor comprises:
a comb blade urging member that urges the comb-shaped outer blade with respect to the head portion in the second direction;
a mesh blade urging member that urges the at least one mesh-shaped outer blade with respect to the head portion in the second direction; and
an engaging mechanism that, when the at least one mesh-shaped outer blade is moved toward the head portion against urging force of the mesh blade urging member, moves the comb-shaped outer blade in a state where the at least one mesh-shaped outer blade projects from the comb-shaped outer blade with respect to the head portion.

2. The electric razor according to claim 1, wherein
the engaging mechanism comprises:
a first engaging portion that has a fixed relationship with the comb-shaped outer blade, and projects toward a side of the at least one mesh-shaped outer blade in a third direction intersecting the first direction and the second direction; and
a second engaging portion that has a fixed relationship with the at least one mesh-shaped outer blade, and projects toward a side of the comb-shaped outer blade in the third direction, and
in the second direction, the first engaging portion is disposed at a position closer to the head portion than the second engaging portion is, and the first engaging portion and the second engaging portion engage with each other in a state where the at least one mesh-shaped outer blade projects from the comb-shaped outer blade.

3. The electric razor according to claim 1, wherein the comb-shaped outer blade comprises:
a base portion having a rod shape extending in the first direction; and
a rod-shaped open blade portion having a cantilever rod shape and projecting from the base portion in a direction intersecting the first direction.

4. The electric razor according to claim 3, comprising:
an attaching portion having a plate shape and extending in the first direction and the second direction which intersects the first direction; and
a bent blade portion that connects the base portion and the attaching portion,
wherein the bent blade portion comprises:
a projecting portion projecting from the base portion along a third direction intersecting the first direction and the second direction;
a bent portion connected to a tip of the projecting portion; and
a connecting portion that connects the bent portion and the attaching portion.

5. The electric razor according to claim 4, wherein the connecting portion is inclined in such a manner that the connecting portion approaches the base portion in the third direction as a distance from bent portion increases in the second direction and that the connecting portion connects the bent portion with the attaching portion.

6. The electric razor according to claim 4, wherein in the third direction intersecting the first direction and the second direction, an end surface of the bent portion is disposed at a position farther from a tip surface of the open blade portion with respect to the base portion.

7. The electric razor according to claim 1, wherein at least one selected from a group consisting of the comb-shaped outer blade and the at least one mesh-shaped outer blade is curved in such a manner that the central portion thereof projects from both end portions thereof in a plane extending in the first direction and the second direction.

8. The electric razor according to claim 1, wherein
the at least one mesh-shaped outer blade comprises two or more mesh-shaped outer blades; and
the electric razor comprises two sets of blades, each of the two sets of blades being a set of blades in which the two or more mesh-shaped outer blades are arranged on both sides of the comb-shaped outer blade in the third direction intersecting the first direction and the second direction.

9. A blade unit configured to be attached to an electric razor, comprising a comb-shaped outer blade and at least one mesh-shaped outer blade, the blade unit comprising:
a unit base that holds the comb-shaped outer blade extending and the at least one mesh-shaped outer blade each in a first direction so as to be movable in a second direction intersecting the first direction;
a comb blade urging member that urges the comb-shaped outer blade with respect to the unit base in the second direction;
a mesh blade urging member that urges the at least one mesh-shaped outer blade with respect to the unit base in the second direction; and
an engaging mechanism that, when the at least one mesh-shaped outer blade is moved toward the unit base against urging force of the mesh blade urging member, moves the comb-shaped outer blade in a state where the comb-shaped outer blade does not project from the at least one mesh-shaped outer blade with respect to the unit base.
